(19) United States
(12) Patent Application Publication
(10) Pub. No.: US 2020/0033865 A1
(43) Pub. Date: Jan. 30, 2020

(54) Managing Cleaning Robot Behavior

(71) Applicant: QUALCOMM Incorporated, San Diego, CA (US)

(72) Inventors: Daniel Warren MELLINGER, III, Philadelphia, PA (US); Stephen Marc Chaves, Philadelphia, PA (US); Michael Joshua Shomin, Philadelphia, PA (US); Matthew Hyatt Turpin, Waltham, MA (US); John Anthony Dougherty, Philadelphia, PA (US); Ross Eric Kessler, Philadelphia, PA (US); Jonathan Paul Davis, Philadelphia, PA (US); Travis Van Schoyck, Princeton, NJ (US)

(21) Appl. No.: 16/043,592

(22) Filed: Jul. 24, 2018

(51) Int. Cl. G05D 1/02; A47L 9/00; A47L 9/28; G06T 7/20; G06K 9/00; G06T 7/00

(52) U.S. Cl. CPC G05D 1/0219; G05D 1/0246; A47L 9/009; A47L 9/2852; G05D 1/0088; G06K 9/00335; G06K 9/00771; G06T 7/97; G06T 7/20

(57) ABSTRACT

Various embodiments include processing devices and methods for managing cleaning robot behavior. In some embodiments, a processor of the cleaning robot may obtain one or more images of the location of a structure from a camera external to the cleaning robot. The processor may analyze the one or more images of the location. The processor may determine one or more activity parameters of the location based on the analysis of the one or more images of the location. The processor may generate an instruction for the cleaning robot to schedule an operation of the cleaning robot based on the one or more activity parameters. The processor may execute the generated instruction to perform the operation of the cleaning robot.

### BACKGROUND

Autonomous and semiautonomous robotic devices are being developed for a wide range of applications. One such application involves robotic cleaning devices, or cleaning robots. Early cleaning robots were robotic vacuum cleaners that had various problems including colliding with objects and leaving areas uncleaned. More sophisticated cleaning robots have been developed since that time. For example, cleaning robots may be programmed to clean on a predetermined schedule, such as at certain dates and times. However, such cleaning robots blindly follow their cleaning schedule, and are unable to dynamically adapt their cleaning activities to environmental conditions.

### SUMMARY

Various aspects include methods that may be implemented on a processor of a cleaning robot for managing cleaning behavior by a cleaning robot Various aspects may include obtaining, by a processor of a cleaning robot, one or more images of a location of a structure from a camera external to the cleaning robot, analyzing, by the processor, the one or more images of the location, determining, by the processor, one or more activity parameters of an activity in the location based on the analysis of the one or more images of the location, generating, by the processor, an instruction for the cleaning robot to schedule an operation of the cleaning robot based on the one or more activity parameters, and executing, by the processor, the generated instruction to perform the operation of the cleaning robot.

In some aspects, determining the one or more activity parameters of the location based on the analysis of the one or more images of the location may include determining, by the processor, whether a human is present in the location based on the analysis of the one or more images of the location. In such aspects, generating an instruction for the cleaning robot to schedule an operation of the cleaning robot based on the one or more activity parameters may include not scheduling the operation of the cleaning robot in the location if a human is present. In such aspects, generating an instruction for the cleaning robot to schedule an operation of the cleaning robot based on the one or more activity parameters may include scheduling the operation of the cleaning robot to avoid locations where a human is present. In some aspects, determining the one or more activity parameters of the location based on the analysis of the one or more images of the location may include identifying, by the processor, an activity in the location based on the analysis of the one or more images of the location. In some aspects, determining the one or more activity parameters of the location based on the analysis of the one or more images of the location may include determining, by the processor, whether the identified activity is a mess-generating activity based on the analysis of the one or more images of the location.

In some aspects, determining the one or more activity parameters of the location based on the analysis of the one or more images of the location may include determining, by the processor, an activity pattern based on the analysis of the one or more images of the location. In some aspects, determining an activity pattern based on the analysis of the one or more images of the location determining, by the processor, a frequency of the activity based on the analysis of the one or more images of the location. In some aspects, determining an activity pattern based on the analysis of the one or more images of the location may include determining, by the processor, an intensity of the activity based on the analysis of the one or more images of the location.

In some aspects, generating an instruction for the cleaning robot to schedule an operation of the cleaning robot based on the one or more activity parameters may include determining, by the processor, a timing for the operation of the cleaning robot based on the one or more activity parameters. In some aspects, determining the timing for the operation of the cleaning robot based on the one or more activity parameters may include starting the operation of the cleaning robot in response to the one or more activity parameters. In some aspects, determining the timing for the operation of the cleaning robot based on the one or more activity parameters may include scheduling the operation of the cleaning robot for a future time based on the one or more activity parameters. In some aspects, determining the timing for the operation of the cleaning robot based on the one or more activity parameters comprises may include determining a time when the operation of the cleaning robot should not be performed based on the one or more activity parameters. In some aspects, generating an instruction for the cleaning robot to schedule may include determining, by the processor, one or more locations for the operation of the cleaning robot based on the one or more activity parameters. In some aspects, generating an instruction for the cleaning robot to schedule an operation of the cleaning robot based on the one or more activity parameters may include determining, by the processor, an intensity of the operation of the cleaning robot based on the one or more activity parameters.

Various aspects further include a cleaning robot having a processor configured with processor executable instructions to perform operations of any of the methods summarized above. Various aspects further include a processing device for use in a cleaning robot and configured to perform operations of any of the methods summarized above. Various aspects include a cleaning robot having means for performing functions of any of the methods summarized above. Various aspects include a non-transitory processor-readable storage medium having stored thereon processor-executable instructions configured to cause a processor of a cleaning robot to perform operations of any of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a cleaning robot operating within a communication system according to various embodiments.

FIG. 2 is a component block diagram illustrating components of a cleaning robot according to various embodiments.

FIG. 3 is a component block diagram illustrating a processing device suitable for use in cleaning robots implementing various embodiments.

FIG. 4 is a process flow diagram illustrating a method of managing cleaning robot behavior according to various embodiments.

FIG. 5 is a process flow diagram illustrating a method of managing cleaning robot behavior according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include methods that may be implemented on a processor of a cleaning robot that enable the cleaning robot to dynamically adapt autonomous or semiautonomous cleaning behaviors based on information obtained from sources external to the cleaning robot.

As used herein, the term “cleaning robot” refers to one of various types of devices including an onboard processing device configured to provide some autonomous or semi-autonomous capabilities. Various embodiments may be used with a variety of propulsion mechanisms, body designs, and component configurations, and may be configured to perform operations in a variety of environments, including airborne cleaning robots, and water-borne cleaning robots and/or some combination thereof. A cleaning robot may be autonomous including an onboard processing device configured to maneuver and/or navigate while controlling cleaning functions of the cleaning robot without remote operating instructions. In embodiments in which the cleaning robot is semi-autonomous, the cleaning robot may include an onboard processing device configured to receive some information or instructions, such as from a human operator (e.g., via a remote computing device), and autonomously maneuver and/or navigate while controlling cleaning functions of the cleaning robot consistent with the received information or instructions. A cleaning robot may include a variety of components that may perform a variety of cleaning functions. Various embodiments may be performed by or adaptable to a wide range of smart cleaning appliances, including smart dishwashers, washing machines, clothing dryers, garbage collectors/emptiers, and other suitable smart cleaning appliances. For conciseness, term “cleaning robot” will be used herein.

Conventional cleaning robots may be programmed to clean on a predetermined schedule, such as at certain dates and times. However, such cleaning robots blindly follow their cleaning schedule, and are unable to dynamically adapt their cleaning activities to environmental conditions and presence, actions and/or plans of humans.

Various embodiments provide methods, and cleaning robot management systems configured to perform the methods of managing cleaning robot behavior to improve the effectiveness of cleaning operations and/or reduce interference with humans. Various embodiments enable a processor of a cleaning robot to dynamically adapt autonomous or semiautonomous behavior of the cleaning robot based upon information received or obtained from sources external to the cleaning robot.

Various embodiments improve the operation of the cleaning robot by enabling the processor of the cleaning robot to dynamically adjust a date, time, a frequency, a location, and other suitable parameters of one or more operations of the cleaning robot based on an analysis by the processor of the cleaning robot of information from the external sources. Various embodiments improve the operation of the cleaning robot by enabling the processor of the cleaning robot to draw inferences based on an analysis of information from the sources external to the cleaning robot, and to dynamically adjust one or more aspects of operations of the cleaning robot (including scheduling parameters) based on the inferences determined by the processor of the cleaning robot.

In some embodiments, the processor of the cleaning robot may obtain one or more images and/or video (collectively referred to as one or more “images”) of the location of a structure from a camera external to the cleaning robot. The processor of the cleaning robot may analyze the one or more images of the location using one or more of a variety of image analysis processes to analyze the one or more images of the location.

In some embodiments, based on the analysis of the one or more images of the location, the processor may determine one or more activity parameters of an activity occurring in the location. In some embodiments, the processor may determine whether humans are present in the location based on the analysis of the one or more images of the location. In some embodiments, the processor may identify a type of activity in the location based on the analysis of one or more images of the location. In some embodiments, the identified type of activity may include a human activity, an animal activity, or another identifiable activity or occurrence. In some embodiments, the processor may identify whether the activity at the location is a mess-generating activity.

The term “mess” is used herein for conciseness to refer to a material or arrangement of material that is potentially subject to being cleaned by the cleaning robot. In various embodiments, a mess may include dirt, dust, garbage, spilled solid or liquid, human or animal waste, or another material that would readily be understood as a type typically subject to being cleaned up.

In some embodiments, the processor may determine an activity pattern for the location based on the analysis of a plurality of images of the location, particularly images taken over a period of time. In some embodiments, the activity pattern may include a determination of one or more activities and a frequency of such activities in the location. In some embodiments, based on the analysis of the one or more images obtained over time, the processor may determine a frequency of one or more activities that occur in the location, such as rarely, infrequently, often, every day, continuously (e.g., all day, every day), and so forth. In some embodiments, the processor may quantify the determination of one or more activities and/or the frequency of such activities in the location based on, for example, a comparison of a number and/or frequency of detected activities or types of activities over a period of time to one or more activity and/or frequency thresholds.

In some embodiments, based on the analysis of the one or more images obtained over time, the processor may determine an intensity of one or more activities that occur in the location. An intense activity, although it may be infrequent, may be very messy and may require more cleaning than an activity that is not intense. For example, based on the analysis of the one or more images over time, the processor may determine that many people have gathered in a location for an activity. As another example, based on the analysis of the one or more images over time, the processor may determine that a very messy activity occurs at the location (e.g., regardless of a number of participants). As another example, based on the analysis of the one or more images over time, the processor may determine that a location is visited or used by pets or children for activities that may be messy. Other examples are also possible. In some embodiments, the processor may determine a high level or frequency of activity, a low level or frequency of activity, and so forth.

In some embodiments, based on the determined activity parameter(s), the processor of the cleaning robot may generate an instruction for the cleaning robot to schedule an operation of the cleaning robot. In some embodiments, the processor may generate an instruction for the cleaning robot that does not schedule the operation of the cleaning robot in the location if a human is present. In some embodiments, the processor may generate an instruction for scheduling the operation of the cleaning robot to avoid locations where a human is present. In some embodiments, the processor may determine a timing of the operation of the cleaning robot based on the one or more activity parameters. The timing of the operation of the cleaning robot may include one or more of a start time, stop time, a duration, or another suitable timing parameter for the operation of the cleaning robot. In some embodiments, the processor may determine the timing of the operation of the cleaning robot to be performed more or less immediately in response to one or more activity parameters. For example, the processor may determine that based on particular activity parameters the operation of the cleaning robot should be performed as soon as possible, and in response to that determination the processor may start (e.g., trigger performance of) the cleaning robot operation. In some embodiments, the processor may determine the timing of the operation of the cleaning robot to be performed at a future time or at the end of a period of time. For example, the processor may determine based on the particular activity parameters that the operation of the cleaning robot should be performed at some time in the future, and in response to that determination the processor may schedule the cleaning robot operation for the future time. In some embodiments, the processor may determine a time (or a time period) to avoid performing the operation of the cleaning robot based on the one or more activity parameters.

In some embodiments, the processor may determine a frequency of the operation of the cleaning robot based on the one or more activity parameters. For example, certain types of activities, certain levels of activity frequency, and certain levels of activity intensity may require more frequent cleaning than other types of activities and/or lower levels of activity frequency or intensity. In some embodiments, the processor may determine one or more locations of the structure for the operation of the cleaning robot based on the one or more activity parameters. In some embodiments, the processor may determine an intensity the operation of the cleaning robot. For example, based on the one or more activity parameters, the processor may determine that a more vigorous or stringent operation of the cleaning robot is required.

In some embodiments, the processor of the cleaning robot may execute the generated instruction to perform the operation of the cleaning robot.

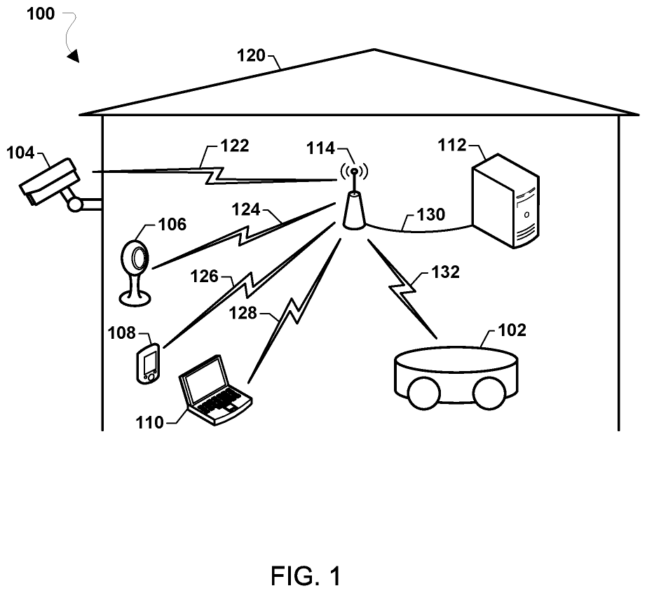

Various embodiments may be implemented within a cleaning robot operating within a variety of communication systems 100, an example of which is illustrated in FIG. 1. With reference to FIG. 1, the communication system 100 may include a cleaning robot 102, various devices that include a camera such as a security camera 104, an in-room camera 106 (e.g., a “nanny cam” or a similar device), a mobile device that includes a camera 108, a portable computer that includes a camera 110, and a hub device 112. The security camera 104, the in-room camera 106, the mobile device camera 108, and the portable computer a camera 110 are referred to herein for conciseness as “cameras”, although it will be recognized that each of these devices may be configured to perform other functions as well. The term “camera” as used herein includes a wide range of image sensor devices capable of capturing images and/or video, and may include visible light sensors, such as charge-coupled device (CCD), complementary metal oxide semiconductor (CMOS), and other suitable devices, as well as sensors capable of detecting electromagnetic radiation beyond the visible spectrum, such as infrared and ultraviolet light.

The hub device 112 may include a wireless communications device 114 that enables wireless communications among the cleaning robot 102 and each of the cameras 104-110 via wireless communication links 122, 124, 126, 128, and 132, respectively. The hub device 112 may communicate with the wireless communication device 112 over a wired or wireless communication link 130.

The wireless communication links 122, 124, 126, 128, and 132 may include a plurality of carrier signals, frequencies, or frequency bands, each of which may include a plurality of logical channels. Each of the wireless communication links may utilize one or more radio access technologies (RATs). Examples of RATs that may be used in one or more of the various wireless communication links 122, 124, 126, 128, and 132 include an Institute of Electrical and Electronics Engineers (IEEE) 802.15.4 protocol (such as Thread, ZigBee, and Z-Wave), any of the Institute of Electrical and Electronics Engineers (IEEE) 16.11 standards, or any of the IEEE 802.11 standards, the Bluetooth® standard, Bluetooth Low Energy (BLE), 6LoWPAN, LTE Machine-Type Communication (LTE MTC), Narrow Band LTE (NB-LTE), Cellular IoT (CIoT), Narrow Band IoT (NB-IoT), BT Smart, Wi-Fi, LTE-U, LTE-Direct, MuLTEfire, as well as relatively extended-range wide area physical layer interfaces (PHYs) such as Random Phase Multiple Access (RPMA), Ultra Narrow Band (UNB), Low Power Long Range (LoRa), Low Power Long Range Wide Area Network (LoRaWAN), and Weightless. Further examples of RATs that may be used in one or more of the various wireless communication links within the communication system 100 include 3GPP Long Term Evolution (LTE), 3G, 4G, 5G, Global System for Mobility (GSM), GSM/General Packet Radio Service (GPRS), Enhanced Data GSM Environment (EDGE), Code Division Multiple Access (CDMA), frequency division multiple access (FDMA), time division multiple access (TDMA), Wideband Code Division Multiple Access (W-CDMA), Worldwide Interoperability for Microwave Access (WiMAX), Time Division Multiple Access (TDMA), and other mobile telephony communication technologies cellular RATs, Terrestrial Trunked Radio (TETRA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, and other mobile telephony communication technologies cellular RATs or other signals that are used to communicate within a wireless, cellular or Internet of Things (IoT) network or further implementations thereof.

In various embodiments, the cleaning robot 102 may perform operations in one or more locations within and proximate to the structure 120. A location may include an interior location of the structure 120 (e.g., a room), an exterior location of the structure 120 (e.g., a porch, a patio, a landing, a balcony, a veranda, and other similar exterior locations), or another location of the structure 120. In some embodiments, the cleaning robot 102 may dynamically manage the scheduling and performance of various operations based on information from sources external to the cleaning robot, including image and/or video information from one or more of the cameras 104-110, as further described below.

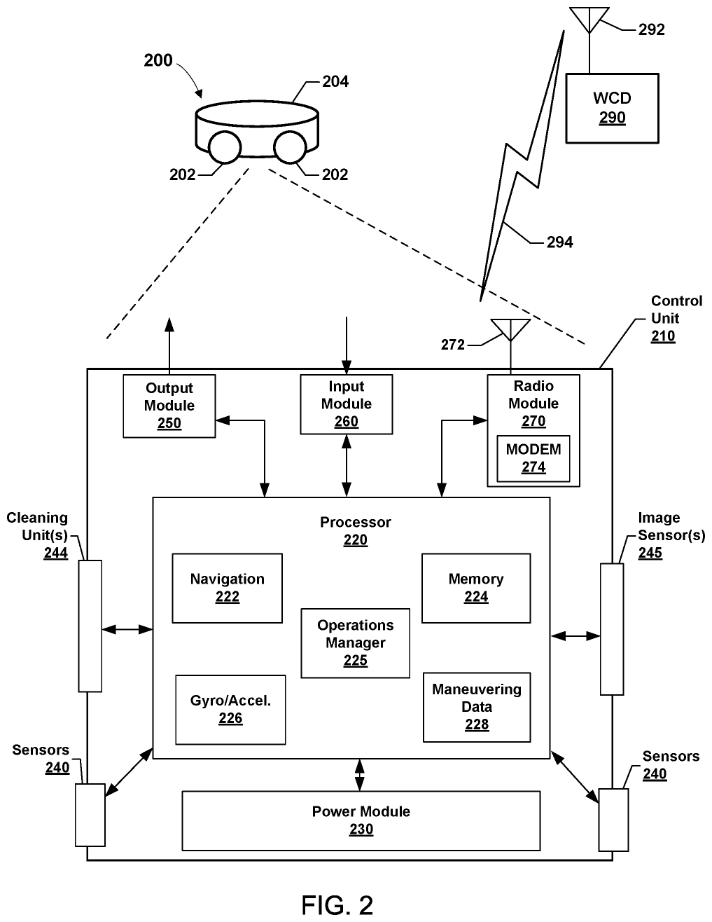

FIG. 2 illustrates an example cleaning robot 200 of a ground vehicle design that utilizes one or more wheels 202 driven by corresponding motors to provide locomotion to the cleaning robot 200. The cleaning robot 200 is illustrated as an example of a cleaning robot that may utilize various embodiments, but is not intended to imply or require that the claims are limited to wheeled ground cleaning robots. For example, various embodiments may be used with a variety of propulsion mechanisms, body designs, and component configurations, and may be configured to perform operations in a variety of environments, including cleaning robots that maneuver at least partially by flying, and water-borne cleaning robots (e.g., pool cleaning robots).

With reference to FIGS. 1 and 2, the cleaning robot 200 may be similar to the cleaning robot 102. The cleaning robot 200 may include a number of wheels 202 and a body 204. The frame 204 may provide structural support for the motors and their associated wheels 202. For ease of description and illustration, some detailed aspects of the cleaning robot 200 are omitted such as wiring, frame structure interconnects, or other features that would be known to one of skill in the art. While the illustrated cleaning robot 200 has wheels 202, this is merely exemplary and various embodiments may include any variety of components to provide propulsion and maneuvering capabilities, such as treads, paddles, skids, or any combination thereof or of other components.

The cleaning robot 200 may further include a control unit 210 that may house various circuits and devices used to power and control the operation of the cleaning robot 200. The control unit 210 may include a processor 220, a power module 230, sensors 240, one or more cleaning units 244, one or more image sensors 245, an output module 250, an input module 260, and a radio module 270.

The processor 220 may be configured with processor-executable instructions to control travel and other operations of the cleaning robot 200, including operations of various embodiments. The processor 220 may include or be coupled to a navigation unit 222, a memory 224, an operations management unit 225, a gyro/accelerometer unit 226, and a maneuvering data module 228. The processor 220 and/or the navigation unit 222 may be configured to communicate with a server through a wireless communication link to receive data useful in navigation, provide real-time position reports, and assess data.

The maneuvering data module 228 may be coupled to the processor 220 and/or the navigation unit 222, and may be configured to provide travel control-related information such as orientation, attitude, speed, heading, and similar information that the navigation unit 222 may use for navigation purposes. The gyro/accelerometer unit 226 may include an accelerometer, a gyroscope, an inertial sensor, an inertial measurement unit (IMU), or other similar sensors. The maneuvering data module 228 may include or receive data from the gyro/accelerometer unit 226 that provides data regarding the orientation and accelerations of the cleaning robot 200 that may be used in navigation and positioning calculations, as well as providing data used in various embodiments for processing images.

The processor 220 may further receive additional information from one or more image sensors 245 (e.g., a camera) and/or other sensors 240. In some embodiments, the image sensor(s) 245 may include an optical sensor capable of infrared, ultraviolet, and/or other wavelengths of light. Information from the one or more image sensors 245 may be used for navigation, as well as for providing information useful in controlling cleaning operations. For example, images of surfaces may be used by the processor 220 to determine a level or intensity of clean operations (e.g., brush speed or pressure) to apply to a given location.

The processor 220 may further receive additional information from one or more other sensors 240. Such sensors 240 may also include a wheel rotation sensor, a radio frequency (RF) sensor, a barometer, a thermometer, a humidity sensor, a chemical sensor (e.g., capable of sensing a chemical in a solid, liquid, and/or gas state), a vibration sensor, a sonar emitter/detector, a radar emitter/detector, a microphone or another acoustic sensor, contact or pressure sensors (e.g., that may provide a signal that indicates when the cleaning robot 200 has made contact with a surface), and/or other sensors that may provide information usable by the processor 220 to determine environmental conditions, as well as for movement operations, navigation and positioning calculations, and other suitable operation.

The power module 230 may include one or more batteries that may provide power to various components, including the processor 220, the sensors 240, the cleaning unit(s) 244, the image sensor(s) 245, the output module 250, the input module 260, and the radio module 270. In addition, the power module 230 may include energy storage components, such as rechargeable batteries. The processor 220 may be configured with processor-executable instructions to control the charging of the power module 230 (i.e., the storage of harvested energy), such as by executing a charging control algorithm using a charge control circuit. Alternatively or additionally, the power module 230 may be configured to manage its own charging. The processor 220 may be coupled to the output module 250, which may output control signals for managing the motors that drive the rotors 202 and other components.

The cleaning robot 200 may be controlled through control of the individual motors of the rotors 202 as the cleaning robot 200 progresses toward a destination. The processor 220 may receive data from the navigation unit 222 and use such data in order to determine the present position and orientation of the cleaning robot 200, as well as the appropriate course towards the destination or intermediate sites. In various embodiments, the navigation unit 222 may include a global navigation satellite system (GNSS) receiver system (e.g., one or more global positioning system (GPS) receivers) enabling the cleaning robot 200 to navigate using GNSS signals. Alternatively or in addition, the navigation unit 222 may be equipped with radio navigation receivers for receiving navigation beacons or other signals from radio nodes, such as navigation beacons (e.g., very high frequency (VHF) omni-directional range (VOR) beacons), access points that use any of a number of a short range RATs (e.g., Wi-Fi, Bluetooth, Zigbee, Z-Wave, etc.), cellular network sites, radio station, remote computing devices, other cleaning robots, etc.

The cleaning units 244 may include one or more of a variety of devices that enable the cleaning robot 200 to perform cleaning operations proximate to the cleaning robot 200 in response to commands from the control unit 210. In various embodiments, the cleaning units 244 may include brushes, vacuums, wipers, scrubbers, dispensers for cleaning solution, and other suitable cleaning mechanisms.

The radio module 270 may be configured to receive navigation signals, such as signals from aviation navigation facilities, etc., and provide such signals to the processor 220 and/or the navigation unit 222 to assist in cleaning robot navigation. In various embodiments, the navigation unit 222 may use signals received from recognizable RF emitters (e.g., AM/FM radio stations, Wi-Fi access points, and cellular network base stations) on the ground.

The radio module 270 may include a modem 274 and a transmit/receive antenna 272. The radio module 270 may be configured to conduct wireless communications with a variety of wireless communication devices (e.g., a wireless communication device (WCD) 290), examples of which include a wireless telephony base station or cell tower (e.g., the base station 104), a network access point (e.g., the access point 106), a beacon, a smartphone, a tablet, or another computing device with which the cleaning robot 200 may communicate (such as the network element 110). The processor 220 may establish a bi-directional wireless communication link 294 via the modem 274 and the antenna 272 of the radio module 270 and the wireless communication device 290 via a transmit/receive antenna 292. In some embodiments, the radio module 270 may be configured to support multiple connections with different wireless communication devices using different radio access technologies.

In various embodiments, the wireless communication device 290 may be connected to a server through intermediate access points. In an example, the wireless communication device 290 may be a server of a cleaning robot operator, a third party service, or a site communication access point. The cleaning robot 200 may communicate with a server through one or more intermediate communication links, such as a wireless telephony network that is coupled to a wide area network (e.g., the Internet) or other communication devices. In some embodiments, the cleaning robot 200 may include and employ other forms of radio communication, such as mesh connections with other cleaning robots or connections to other information sources.

The processor 220 may receive information and instructions generated by the operations manager 225 to schedule and control one or more operations of the cleaning robot 200, including various cleaning operations. In some embodiments, the operations manager 225 may receive information via the communication link 294 from one or more sources external to the cleaning robot 200.

In various embodiments, the control unit 210 may be equipped with an input module 260, which may be used for a variety of applications. For example, the input module 260 may receive images or data from an onboard camera or sensor, or may receive electronic signals from other components (e.g., a payload).

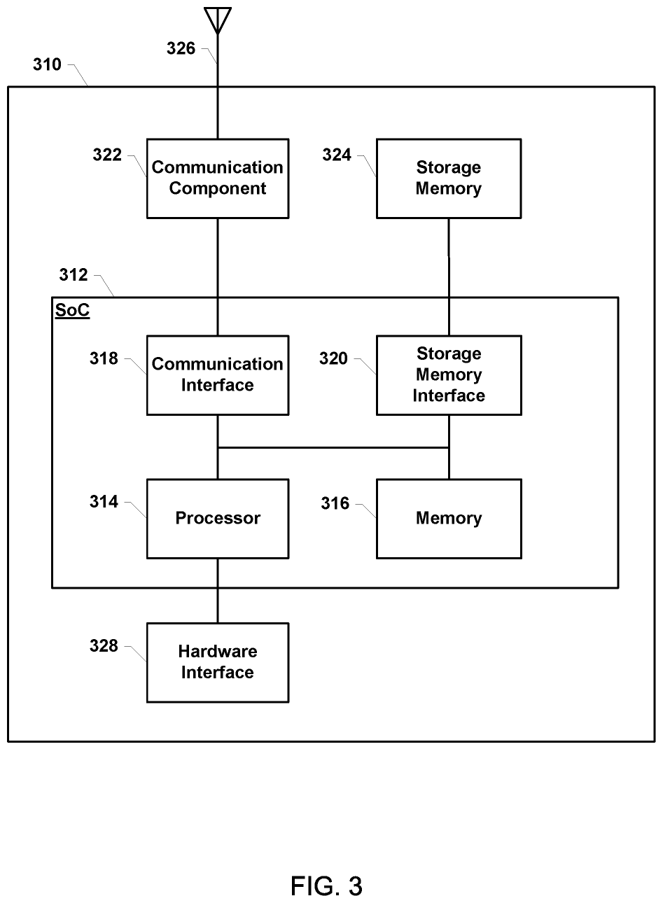

While various components of the control unit 210 are illustrated in FIG. 2 as separate components, some or all of the components (e.g., the processor 220, the output module 250, the radio module 270, and other units) may be integrated together in a single processing device 310, an example of which is illustrated in FIG. 3.

With reference to FIGS. 1-3, the processing device 310 may be configured to be used in a cleaning robot (e.g., the cleaning robot 102 and 200) and may be configured as or including a system-on-chip (SoC) 312. The SoC 312 may include (but is not limited to) a processor 314, a memory 316, a communication interface 318, and a storage memory interface 320. The processing device 310 or the SoC 312 may further include a communication component 322, such as a wired or wireless modem, a storage memory 324, an antenna 326 for establishing a wireless communication link, and/or the like. The processing device 310 or the SoC 312 may further include a hardware interface 328 configured to enable the processor 314 to communicate with and control various components of a cleaning robot. The processor 314 may include any of a variety of processing devices, for example any number of processor cores.

The term “system-on-chip” (SoC) is used herein to refer to a set of interconnected electronic circuits typically, but not exclusively, including one or more processors (e.g., 314), a memory (e.g., 316), and a communication interface (e.g., 318). The SoC 312 may include a variety of different types of processors 314 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 312 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 312 may include one or more processors 314. The processing device 310 may include more than one SoC 312, thereby increasing the number of processors 314 and processor cores. The processing device 310 may also include processors 314 that are not associated with an SoC 312 (i.e., external to the SoC 312). Individual processors 314 may be multicore processors. The processors 314 may each be configured for specific purposes that may be the same as or different from other processors 314 of the processing device 310 or SoC 312. One or more of the processors 314 and processor cores of the same or different configurations may be grouped together. A group of processors 314 or processor cores may be referred to as a multi-processor cluster.

The memory 316 of the SoC 312 may be a volatile or non-volatile memory configured for storing data and processor-executable instructions for access by the processor 314. The processing device 310 and/or SoC 312 may include one or more memories 316 configured for various purposes. One or more memories 316 may include volatile memories such as random access memory (RAM) or main memory, or cache memory.

Some or all of the components of the processing device 310 and the SoC 312 may be arranged differently and/or combined while still serving the functions of the various aspects. The processing device 310 and the SoC 312 may not be limited to one of each of the components, and multiple instances of each component may be included in various configurations of the processing device 310.

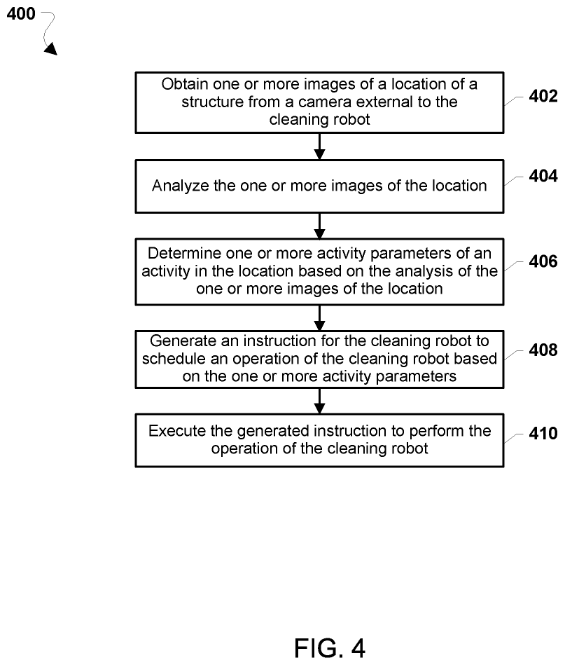

FIG. 4 illustrates a method 400 of managing cleaning robot behavior according to various embodiments. With reference to FIGS. 1-4, a processor of a cleaning robot (e.g., the processor 220, the processing device 310, the SoC 312, and/or the like) and hardware components and/or software components of the cleaning robot may obtain information from one or more sources external to the cleaning robot and dynamically schedule and perform various cleaning robot operations.

In block 402, the processor of the cleaning robot may obtain one or more images of the location of a structure from a camera external to the cleaning robot. In some embodiments, the images may include one or more images and/or video of the location. In some embodiments the camera external to the leading robot may include one or more of the cameras 104-110. In some embodiments, the one or more of the cameras 104-110 may be in communication with the cleaning robot, such as via a wired or wireless communication link and provide the images more or less as they are generated. In some embodiments, the one or more of the cameras 104-110 may transmit the images to the cleaning robot, such as via a wired or wireless communication link, periodically (e.g., hourly) or episodically (e.g., upon detecting motion in the location viewed by a camera). In some embodiments, the processor of the cleaning robot may submit a request (e.g., a GET request) for images to one or more cameras or a computing device configured to accept and store images from the one or more cameras, and receive images in response via a wired or wireless communication link. In some embodiments, a computing device configured to accept and store images from the one or more cameras may perform analysis on images to identify images showing a mess in need of cleaning and transmit those images (i.e., only relevant images) to the processor of the cleaning robot for analysis. Other mechanisms for providing images to the processor of the cleaning robot may also be used in block 402. In some embodiments, the processor may receive images of the location from a sensor of the cleaning robot (e.g., the image sensor 245). In some embodiments, the processor may use one or more images from a sensor of the cleaning robot in combination with, or supplemental to, the image(s) from the camera external to the cleaning robot. In some embodiments, the processor of the cleaning robot may obtain sensor information from one or more of the cleaning robot's other sensors (e.g., the sensors 240).

In block 404, the processor of the cleaning robot may analyze the one or more images of the location. In some embodiments, the processor of the cleaning robot may employ one or more of a variety of image analysis processes to analyze the one or more images of the location. Such image analysis processes may include pattern recognition, gesture recognition, object recognition, detection and tracking of objects, people, or animals, human or animal activity analysis, analysis of behavioral cues, and other suitable image analysis processes. In some embodiments, the processor of the cleaning robot may compare an analysis of the one or more images to a data structure (e.g., stored in a memory of the cleaning robot) to perform and image or pattern matching process. In some embodiments, the processor of the cleaning robot may employ one or more machine learning techniques to analyze the one or more images.

In some embodiments, the processor may analyze one or more images from a sensor of the cleaning robot in combination with, or supplemental to, image(s) from a camera external to the cleaning robot. For example, the processor of the cleaning robot may augment the analysis of the one or more images from the camera external to the cleaning robot with an analysis of one or more images obtained with a sensor of the cleaning robot. As another example, the processor of the cleaning robot may augment the analysis of the image(s) from the external camera external to the cleaning robot with an analysis of sensor information from another sensor of the cleaning robot. For example, the processor may identify information from an external microphone as the sound of breaking glass. As another example, the processor may detect a temperature of an object in the location based on information from an infrared sensor (e.g., heat emitted by recent animal waste). As another example, the processor may analyze information from a humidity sensor or a chemical sensor to identify a mess, determine a type of mess, and other suitable determinations.

In some embodiments, the processor of the cleaning robot may provide one or more images to another device (e.g., the hub device 112) for image processing, or to assist with the processing of the one or more images. In some embodiments, the other device may receive one or more images directly from an external sensor (i.e., external to the cleaning robot). In some embodiments, a processor of the other device may perform a certain level of analysis of the one or more images and provide the results of its analysis to the processor of the cleaning robot. For example, the processor of the cleaning robot may send one or more images to the hub device (and/or the hub device may receive one or more images from an external sensor), and a processor of the hub device may analyze the image(s). For example, the processor of hub device may identify one or more objects in the image(s). As another example, the processor of the hub device may determine one or more types of objects in the image(s). In some embodiments, the processor of the hub device may provide the results of its analysis (i.e., the identification of the one or more objects, types of object, and the like) to the cleaning robot, and the processor of the cleaning robot may incorporate the analytical results from the hub device into the cleaning robot processor's analysis of the images and/or other information.

In block 406, the processor of the cleaning robot may determine one or more activity parameters of the location based on the analysis of the one or more images of the location. In some embodiments, the processor may determine the one or more activity parameters of the location based on an analysis of the one or more images of the location over time. In some embodiments, the one or more activity parameters may include a determination of whether a human is or is not present, an activity in the location, an activity pattern for the location, or another suitable cleaning parameter. The determination and use of activity parameters is further discussed below. In some embodiments, the processor may accumulate information, such as the one or more images of the location, analyses of the one or more images of the location, and or one or more previously determined activity parameters, and may apply one or more machine learning techniques to the accumulated information over time to determine, or to improve the determination, of one or more activity parameters in the location. In some embodiments, the processor of the cleaning robot may determine the one or more activity parameters in the location based on the analysis of the one or more images of the location from the external camera and based on an analysis of one or more images obtained with an image sensor of the cleaning robot. In some embodiments, the processor of the cleaning robot may determine the one or more activity parameters in the location based on the analysis of the one or more images of the location from the external camera and based on an analysis of information obtained with another sensor of the cleaning robot.

In block 408, the processor of the cleaning robot may generate an instruction for the cleaning robot to schedule an operation of the cleaning robot based on the one or more activity parameters. In some embodiments, the processor may determine a timing of the operation of the cleaning robot based on the one or more activity parameters. The timing of the operation of the cleaning robot may include one or more of a start time, stop time, a duration, a frequency, or another suitable timing parameter for the operation of the cleaning robot. In some embodiments, the processor may determine a time or time period at or during which an operation of the cleaning robot should not be performed. In some embodiments, the processor may determine that the operation of the cleaning robot should be performed more or less immediately in response to some activity or activity parameter. For example, the processor may determine based on particular activity parameters that the operation of the cleaning robot should be performed as soon as possible, and in response to that determination the processor may start (e.g., trigger performance of) the cleaning robot operation. In some embodiments, the processor may determine that the operation of the cleaning robot should be performed at a future time or at the end of a period of time. For example, the processor may determine based on the particular activity parameters that the operation of the cleaning robot should be performed at a particular time in the future, and in response to that determination the processor may schedule the cleaning robot operation for that particular future time. In some embodiments, the processor may determine one or more locations of the structure where the operation of the cleaning robot should be performed or not performed based on the one or more activity parameters.

In block 410, the processor may execute the generated instruction to perform the operation of the cleaning robot.

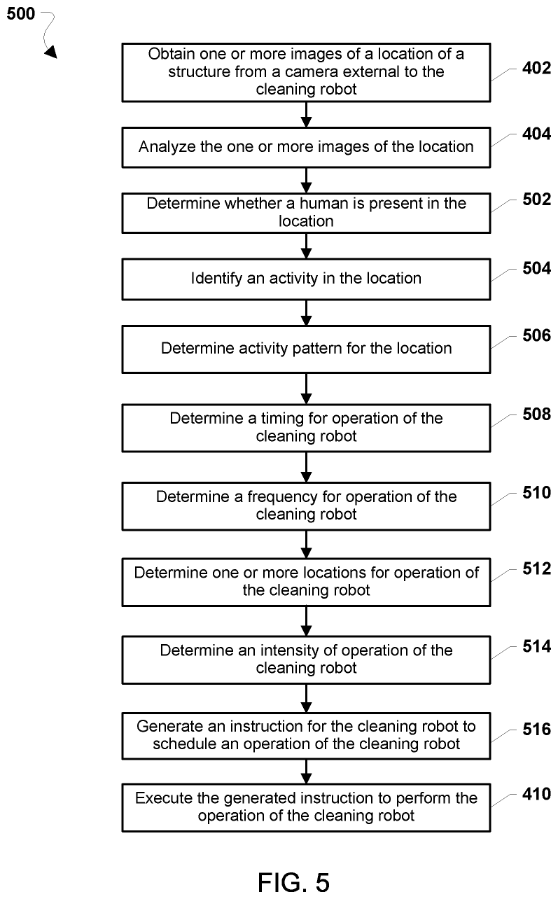

FIG. 5 illustrates a method 500 of managing cleaning robot behavior according to various embodiments. With reference to FIGS. 1-5, a processor of a cleaning robot (e.g., the processor 220, the processing device 310, the SoC 312, and/or the like) and hardware components and/or software components of the cleaning robot may obtain information from one or more sources external to the cleaning robot and dynamically schedule and perform various cleaning robot operations. In blocks 402, 404, and 410, the processor of the cleaning robot may perform operations of like-numbered blocks of the method 400 as described.

In block 404, the processor of the cleaning robot may analyze the one or more images of the location as described.

In block 502, the processor of the cleaning robot may determine whether a person is present (or is not present) in the location. In some embodiments, the processor may determine based on whether a human is or is not present whether or not the structure is unoccupied (e.g., no one is home, all personnel have left work, etc.). In such embodiments, the processor may schedule an operation of the cleaning robot in response to determining that the structure is unoccupied. In some embodiments, the processor may schedule an operation of the cleaning robot in one or more locations where a person is not present. In some embodiments, the processor may not schedule an operation of the cleaning robot in a location where a person is present. In some embodiments, the processor may schedule an operation of the cleaning robot to avoid locations where a person is present. For example, the processor may schedule the cleaning robot operation in locations where a person is not present, and schedule the cleaning robot to stay away from, or pass by, or to travel around or away from, locations where a person is present.

In block 504, the processor of the cleaning robot may identify an activity in the location. In some embodiments, the processor of the cleaning robot may compare the one or more images (or an analysis of the one or more images) to a data structure (e.g., stored in a memory of the cleaning robot) to perform and image or pattern matching process to identify the activity in the location. In some embodiments, the processor of the cleaning robot may employ one or more machine learning techniques to analyze the one or more images to identify the activity in the location. For example in some instances, the processor may identify a solo or group human activity, for example, standing, sitting, eating, watching TV, playing a game, sleeping, having a party, and other identifiable human activities. For example in some instances, the processor may identify an animal activity (e.g., an activity of a family pet). In some embodiments, the processor may identify another activity occurrence. In some embodiments, the processor may not schedule an operation of the cleaning robot in the location at a time where certain activities are occurring (e.g., watching TV, sleeping, etc.). In some embodiments, the processor may schedule an operation of the cleaning robot in the location at a time after certain activities have occurred (e.g., children playing, a cocktail party, etc.).

In some embodiments, the processor of the cleaning robot may identify a mess in the location based on the analysis of the one or more images of the location. In some embodiments, the identified mess may include dirt, dust, garbage, spilled solid or liquid, human or animal waste, or another similar material. In some embodiments, the processor may identify a mess-generating activity at the location based on the analysis of the one or more images of the location. For example, the mess-generating activity may include an animal emitting waste, a child spilling a drink, a partygoer dropping food, a person tracking mud through a room, and other similar mess-generating activities.

In block 506, the processor of the cleaning robot may determine an activity pattern for the location. In some embodiments, the processor may determine the activity pattern for the location based on the analysis of the one or more images of the location. In some embodiments, the activity pattern may include a determination of one or more activities and a frequency of such activities in the location. In some embodiments, based on the analysis of the one or more images obtained over time, the processor may determine a frequency of one or more activities that occur in the location and/or an intensity of one or more activities that occur in the location. In some embodiments, the processor may quantify the determination of one or more activities and/or the frequency of such activities in the location based on, for example, a comparison of a number and/or frequency of detected activities or types of activities over a period of time to one or more activity and/or frequency thresholds.

In block 508, the processor of the cleaning robot may determine a timing for an operation of the cleaning robot. In some embodiments, the processor may determine the timing for the operation of cleaning robot based on the one or more activity parameters. In some embodiments, the processor may determine the timing for the operation of the cleaning robot based on the analysis of the one or more images of the location. For example, the processor may determine the timing for the operation of the cleaning robot based on the identified human presence in the location, the identified activity in the location, and/or the determined activity pattern in the location. In some embodiments, the timing may include a start time and/or a stop time of the operation of the cleaning robot. In some embodiments, the timing may include a duration of the operation of the cleaning robot. In some embodiments, the processor may determine a time or time period when an operation of the cleaning robot should not be performed based on the one or more activity parameters. For example, based on whether a human is present in the location, the identified activity in the location, and/or the determined activity pattern in the location, the processor may determine a time or time period to schedule or avoid scheduling the cleaning robot operation. The timing may further include other suitable timing parameters for the operation of the cleaning robot.

In block 510, the processor of the cleaning robot may determine a frequency for an operation of the cleaning robot. In some embodiments, the processor may determine the timing for the operation of the cleaning robot based on the one or more activity parameters. For example, the processor may determine the frequency for the operation of the cleaning robot based on the identified human presence in the location, the identified activity in the location, and/or the determined activity pattern in the location.

In block 512, the processor of the cleaning robot may determine one or more locations for an operation of the cleaning robot. In some embodiments, the processor may determine one or more locations based on the one or more activity parameters. In some embodiments, the processor may determine the one or more locations for the operation of the cleaning robot based on the analysis of the one or more images of the location. For example, the processor may determine the one or more locations for the operation of the cleaning robot based on whether a human is present in the location, the identified activity in the location, and/or the determined activity in the location. In some embodiments, the processor may determine a timing for each of a plurality of determined locations for an operation of the cleaning robot (e.g., a start time, stop time, duration, frequency, or another suitable timing parameter). In some embodiments, the processor may determine one or more locations in which the cleaning robot operation should not be performed based on the analysis of the one or more images of the location. For example, the processor may determine that the operation of the cleaning robot should not be performed in one or more locations based on a determination that a human is present in the locations, the identified activity in the locations, and/or the determined activity in the locations.

In block 514, the processor of the cleaning robot may determine an intensity of the operation of the cleaning robot. In some embodiments, the processor may determine the intensity of the operation based on the one or more activity parameters. In some embodiments, the processor may determine the intensity of the operation based on the analysis of the one or more images of the location. For example, the processor may determine the intensity of the operation based on the identified human presence in the location, the identified activity in the location, and/or the determined activity in the location. For example, the cleaning robot may operate nominally in a power-saving type mode during normal up-keep cleaning in order to prolong battery life if significant cleaning is not expected to be required. However, if the analyzed activity parameters for a location suggest that significant cleaning may be required (e.g., in a high-traffic location), the processor may determine that a higher intensity cleaning operation (e.g., a higher-power, more intense cleaning mode) is appropriate to clean the area effectively. In some embodiments, the intensity of the cleaning robot operation may be a discrete parameter, such as a power-save mode vs. a high-power mode. In some embodiments, the intensity of the cleaning robot operation may be within a range of intensities (e.g., in a range from 0 to 1, from 1 to 10, etc. in which the value is related to an intensity of the cleaning operation). In some embodiments, the processor may determine two or more intensities of the cleaning robot operation or may vary the intensity of cleaning operations based on the identified human presence in the location, the identified activity in the location, and/or the determined activity in the location.

In block 516, the processor of the cleaning robot may generate an instruction for the cleaning robot to schedule an operation of the cleaning robot. In some embodiments, the processor the cleaning robot may generate the instruction based on the one or more activity parameters. In some embodiments, the processor the cleaning robot may generate the instruction based on the determined timing, the determined frequency, and/or the determined one or more locations for the operation of the cleaning robot.

In block 410, the processor of the cleaning robot may execute the generated instruction to perform the operation of the cleaning robot, as described.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 400 and 500 may be substituted for or combined with one or more operations of the methods 400 and 500, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

What is claimed is:

1. A method of managing cleaning behavior by a cleaning robot, comprising:
obtaining, by a processor of a cleaning robot, one or more images of a location of a structure from a camera external to the cleaning robot;
analyzing, by the processor, the one or more images of the location;
determining, by the processor, one or more activity parameters of an activity in the location based on the analysis of the one or more images of the location;
generating, by the processor, an instruction for the cleaning robot to schedule an operation of the cleaning robot based on the one or more activity parameters; and
executing, by the processor, the generated instruction to perform the operation of the cleaning robot.

2. The method of claim 1, wherein determining the one or more activity parameters of the location based on the analysis of the one or more images of the location comprises:
determining, by the processor, whether a human is present in the location based on the analysis of the one or more images of the location.

3. The method of claim 2, wherein generating an instruction for the cleaning robot to schedule an operation of the cleaning robot based on the one or more activity parameters comprises not scheduling the operation of the cleaning robot in the location if a human is present.

4. The method of claim 2, wherein generating an instruction for the cleaning robot to schedule an operation of the cleaning robot based on the one or more activity parameters comprises scheduling the operation of the cleaning robot to avoid the locations where a human is present.

5. The method of claim 1, wherein determining the one or more activity parameters of the location based on the analysis of the one or more images of the location comprises:
identifying, by the processor, an activity in the location based on the analysis of the one or more images of the location.

6. The method of claim 1, wherein determining the one or more activity parameters of the location based on the analysis of the one or more images of the location comprises:
identifying, by the processor, an activity in the location based on the analysis of the one or more images of the location; and
determining, by the processor, whether the identified activity is a mess-generating activity based on the analysis of the one or more images of the location.

7. The method of claim 1, wherein determining the one or more activity parameters of the location based on the analysis of the one or more images of the location comprises:
determining, by the processor, an activity pattern based on the analysis of the one or more images of the location.

8. The method of claim 7, wherein determining an activity pattern based on the analysis of the one or more images of the location comprises:
determining, by the processor, a frequency of the activity based on the analysis of the one or more images of the location.

9. The method of claim 7, wherein determining an activity pattern based on the analysis of the one or more images of the location comprises:
determining, by the processor, an intensity of the activity based on the analysis of the one or more images of the location.

10. The method of claim 1, wherein generating an instruction for the cleaning robot to schedule an operation of the cleaning robot based on the one or more activity parameters comprises:
determining, by the processor, a timing for the operation of the cleaning robot based on the one or more activity parameters.

11. The method of claim 10, wherein determining the timing for the operation of the cleaning robot based on the one or more activity parameters comprises starting the operation of the cleaning robot in response to the one or more activity parameters.

12. The method of claim 10, wherein determining, by the processor, the timing for the operation of the cleaning robot based on the one or more activity parameters comprises scheduling the operation of the cleaning robot for a future time based on the one or more activity parameters.

13. The method of claim 10, wherein determining, by the processor, the timing for the operation of the cleaning robot based on the one or more activity parameters comprises determining a time when the operation of the cleaning robot should not be performed based on the one or more activity parameters.

14. The method of claim 1, wherein generating an instruction for the cleaning robot to schedule an operation of the cleaning robot based on the one or more activity parameters comprises:
determining, by the processor, one or more locations for the operation of the cleaning robot based on the one or more activity parameters.

15. The method of claim 1, wherein generating an instruction for the cleaning robot to schedule an operation of the cleaning robot based on the one or more activity parameters comprises:
determining, by the processor, an intensity of the operation of the cleaning robot based on the one or more activity parameters.

16. A cleaning robot, comprising:
a memory; and
a processor configured with processor-executable instructions to:
obtain one or more images of a location of a structure from a camera external to the cleaning robot;
analyze the one or more images of the location;
determine one or more activity parameters of an activity in the location based on the analysis of the one or more images of the location;
generate an instruction for the cleaning robot to schedule an operation of the cleaning robot based on the one or more activity parameters; and
execute the generated instruction to perform the operation of the cleaning robot.

17. The cleaning robot of claim 16, wherein the processor is further configured to:
determine whether a human is present in the location based on the analysis of the one or more images of the location.

18. The cleaning robot of claim 17, wherein the processor is further configured to generate an instruction for the cleaning robot to schedule an operation of the cleaning robot that includes not scheduling the operation of the cleaning robot in the location if a human is present.

19. The cleaning robot of claim 17, wherein the processor is further configured to:
generate an instruction for the cleaning robot to schedule an operation of the cleaning robot that avoids locations where a human is present.

20. The cleaning robot of claim 16, wherein the processor is further configured to:
identify an activity in the location based on the analysis of the one or more images of the location.

21. The cleaning robot of claim 16, wherein the processor is further configured to:
identify an activity in the location based on the analysis of the one or more images of the location; and
determine whether the identified activity is a mess-generating activity based on the analysis of the one or more images of the location.

22. The cleaning robot of claim 16, wherein the processor is further configured to:
determine an activity pattern based on the analysis of the one or more images of the location.

23. The cleaning robot of claim 22, wherein the processor is further configured to:
determine a frequency of the activity based on the analysis of the one or more images of the location.

24. The cleaning robot of claim 22, wherein the processor is further configured to:
determine an intensity of the activity based on the analysis of the one or more images of the location.

25. The cleaning robot of claim 16, wherein the processor is further configured to:
determine a timing for the operation of the cleaning robot based on the one or more activity parameters.

26. The cleaning robot of claim 25, wherein the processor is further configured to start the operation of the cleaning robot in response to the one or more activity parameters.

27. The cleaning robot of claim 25, wherein the processor is further configured to schedule the operation of the cleaning robot for a future time based on the one or more activity parameters.

28. The cleaning robot of claim 25, wherein the processor is further configured to determine a time when the operation of the cleaning robot should not be performed based on the one or more activity parameters.

29. The cleaning robot of claim 16, wherein the processor is further configured to:
determine one or more locations for the operation of the cleaning robot based on the one or more activity parameters.

30. The cleaning robot of claim 16, wherein the processor is further configured to:
determine an intensity of the operation of the cleaning robot based on the one or more activity parameters.
